(19) United States
(12) Patent Application Publication
(10) Pub. No.: US 2005/0106440 A1
(43) Pub. Date: May 19, 2005

(54) Proton conductor and method for producing the same

(75) Inventor: Teruaki Komiya, Fujimi-shi (JP)

Correspondence Address: LAHIVE & COCKFIELD, LLP., 28 STATE STREET, BOSTON, MA, 02109, US

(73) Assignee: Honda Motor Co., Ltd., Tokyo (JP)

(21) Appl. No.: 10/993,823

(22) Filed: Nov. 19, 2004

(30) Foreign Application Priority Data
Nov. 19, 2003 (JP) 2003-389894

(51) Int. Cl. H01M 8/10; C25C 7/04; C25B 13/00

(52) U.S. Cl. 429/33; 429/30; 204/296; 521/27

(57) ABSTRACT

An acidic group-containing solid polymer, having an acidic group such as a sulfonic acid group, a phosphoric acid group, and/or a phosphonic acid group, is dissolved in an organic solvent other than methanol. An ionic liquid is added to the solution to prepare a casting liquid. The casting liquid is subjected to casting in a cavity formed by an opening of a frame and a sheet member, each of which is composed of PTFE (fluorine-containing polymer material). Thereafter, the solvent is removed to yeild a proton conductor membrane.

### BACKGROUND OF THE INVENTION

1. Field of the Invention

The present invention relates to a proton conductor, which is usable as an electrolyte for various electrochemical cells including, for example, fuel cells such as hydrogen fuel cells and direct methanol type fuel cells, and electrolysis apparatuses for electrolyzing water to produce hydrogen and oxygen, together with a method for producing the same.

2. Description of the Related Art

A fuel cell comprises an electrolyte, which is interposed between an anode electrode to which a fuel gas containing hydrogen is supplied and a cathode electrode to which an oxygen-containing gas such as air is supplied. The electrolyte acts such that hydrogen ions (protons), which are produced on the anode electrode by ionizing hydrogen contained in the fuel gas, are moved toward the cathode electrode. In other words, the electrolyte acts as a proton conductor.

A humidified perfluorosulfonic acid polymer membrane material has been widely used as the proton conductor described above. The proton conductivity of the membrane decreases the more dried the membrane becomes. Therefore, in order to maintain the power generation characteristic of the fuel cell, steam is introduced into the fuel gas or the oxygen-containing gas in order to continuously supply water to the membrane, and/or a cooling medium is supplied to the inside of the fuel cell in order to retain the operation temperature thereof at 80 to 90° C., so that the membrane is prevented from becoming dried.

In such cases, it is necessary to provide a humidifier for introducing steam into the gas and/or to provide a large-scale cooling system for circulating a large amount of cooling medium, in order to efficiently cool the fuel cell. Therefore, the overall size of the fuel cell system is increased.

In recent years, attempts have been made to manufacture a proton conductor that exhibits excellent proton conductivity even in high temperature environments or in low humidity environments. When such a proton conductor is used as the electrolyte to construct a fuel cell, then it is unnecessary to provide a humidifier and a cooling system, and hence the arrangement of the fuel cell system becomes simplified and small in size.

In Marc Doyle et al., “High-Temperature Proton Conducting Membranes Based on Perfluorinated Ionomer Membrane-Ionic Liquid Composites,” Journal of The Electrochemical Society, 2000, 1, vol. 147, pp. 34-37, it has been suggested that an ionic liquid, such as 1-butyl, 3-methylimidazolinium trifluoromethane sulfonate (BMITF) and 1-butyl, 3-methylimidazolinium tetrafluoroborate (BMIBF₄), can be absorbed by a perfluorosulfonic acid membrane such as Nafion (registered trade name) in order to prepare a proton conductor membrane. According to this document, Nafion is immersed in a BMITF or BMIBF₄ liquid, and thus the Nafion becomes impregnated with the liquid. The amount of impregnation of the ionic liquid within the proton conductor membrane, obtained as described above, is about 40 to 60% by weight with respect to the weight of Nafion.

Japanese Laid-Open Patent Publication No. 2003-123791 discloses a proton conductor membrane obtained by mixing and agitating a Nafion solution, containing 5% by weight of perfluorosulfonic acid, 15% by weight of a water-methanol solvent, and 10 to 30% by weight of (1-buty, 3-methylimidazolinium bis[trifluoromethyl]sulfonyl)imide (EMITFSI) or 1-ethyl, 3-methylimidazolinium trifluoromethane sulfonate (EMITf), with respect to the weight of perfluorosulfonic acid in the solution, followed by being subjected to casting in a heat-resistant glass petri dish, and thereafter being dried and heat-treated at 80 to 150° C.

It is well known that water is produced on the cathode electrode when the fuel cell is operated. Such water is discharged externally of the fuel cell system via an air discharge flow passage or a fuel gas discharge flow passage, as the water is moved toward the anode electrode via the electrolyte.

A proton conductor membrane obtained according to the technique of Marc Doyle et al. has a small retaining force for the ionic liquid. Therefore, when the fuel cell employs such a proton conductor membrane as an electrolyte, the ionic liquid is accompanied by water produced during operation of the fuel cell, and is discharged externally of the system. As a result, the proton conductivity of the electrolyte is lowered, and the power generation performance of the fuel cell is deteriorated.

On the other hand, according to the invention described in Japanese Laid-Open Patent Publication No. 2003-123791, the proton conductor membrane has a relatively large retaining force for the ionic liquid. Therefore, discharging of the ionic liquid from the fuel cell can be suppressed.

However, in the case of this technique, when an ionic liquid of not less than 30% by weight is added to Nafion, and the casting liquid is subjected to casting on heat-resisting glass in order to improve proton conductivity, fine cracks are generated within the entire membrane. If such a cracked membrane is used as the electrolyte, then oxygen supplied to the cathode electrode consequently becomes mixed with the fuel gas supplied to the anode electrode via the cracks, and a satisfactory electrode reaction cannot occur.

Further, if the amount of ionic liquid added to the membrane is increased, the strength of the membrane becomes deteriorated. Therefore, in many cases, the membrane is easily broken into small pieces when the membrane is exfoliated from the glass petri dish.

### SUMMARY OF THE INVENTION

A general object of the present invention is to provide a proton conductor, which is excellent in its ability to retain a large amount of ionic liquid, and hence makes it possible to ensure favorable characteristics for an electrochemical cell.

A principal object of the present invention is to provide a proton conductor, which does not require any additional equipment, for example, a humidifier or a cooling system, when used in a fuel cell or other electrochemical cells, and which makes it possible to construct a compact fuel cell system having a simple structure.

In the proton conductor of the present invention, a retention ratio of the ionic liquid in a matrix, which is exhibited after passage or elapse of 24 hours after immersion in water, is not less than 50%, preferably not less than 90%, and more preferably 100%.

Preferred acidic group-containing solid polymers are represented by a polymer having, as an acidic group thererof, a sulfonic acid group, a phosphoric acid group, or a phosphonic acid group.

Preferred ionic liquids are represented by substances in which an ionic bond is formed by nitrogen-containing organic cations and anions.

Another object of the present invention is to provide a production method, which makes it possible to obtain a proton conductor easily and conveniently, wherein the proton conductor is capable of retaining a large amount of ionic liquid therein, and wherein the proton conductor is excellent in its liquid retaining ability.

In the above production method, an organic solvent other than methanol is used, and casting is performed for producing the proton conductor.

Depending on the type of acidic group-containing solid polymer used, compatible materials are selected for the organic solvent. For example, it is preferable that propanol or butanol be used as the organic solvent when the acidic group-containing solid polymer is a perfluorosulfonic acid-based polymer. It is preferable that N-methyl-pyrrolidone, dimethylformamide, dimethylacetamide, or dimethylsulfoxide be used as the organic solvent when the acidic group-containing solid polymer is an acidic group-containing hydrocarbon-based polymer.

A fuel cell, including a proton conductor electrolyte as described above, exhibits excellent power generation performance over a long period of time.

The proton conductor can be also used as an electrolyte in other types of electrochemical cells, such as an electrolysis apparatus.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic overall perspective view illustrating a casting vessel, which is used when a proton conductor according to an embodiment of the present invention is manufactured;

FIG. 2 is a schematic overall perspective view illustrating a test piece and electrodes used for measuring proton conductivity of the proton conductor according to the embodiment of the present invention; and

FIG. 3 is a table illustrating the relationship between proton conductivity and the ratio of the ionic liquid with respect to Nafion, in respective membranes (proton conductors) prepared in accordance with Examples 1 and 2 and Comparative Examples 1, 2, and 4.

### DESCRIPTION OF THE PREFERRED EMBODIMENTS

The proton conductor and the method for producing the same according to a preferred embodiment of the present invention will be explained in detail below with reference to the accompanying drawings.

In the proton conductor, according to an embodiment of the present invention, an acidic group-containing solid polymer having an acidic group is used as a matrix, wherein an ionic liquid is retained by the matrix.

The acidic group herein implies a “group that allows a polymer bonded to the acidic group to become acidic.” That is, the acidic group-containing solid polymer exhibits the property of acidity. The ionic liquid herein implies a compound, which is a liquid at ambient temperature, and in which cations and anions thereof form an ionic bond. The ionic liquid is also referred to as an “ambient temperature molten salt” or a “room temperature molten salt.”

The acidic group-containing solid polymer serving as the matrix may be a Brøonsted acid, but is not specifically limited to such a material. However, it is preferable to use a polymer having an acidic group consisting of a sulfonic acid group, a phosphoric acid group, and/or a phosphonic acid group.

Specified examples of the acidic group-containing solid polymer include a perfluorosulfonic acid polymer represented by the following chemical formula (1) and a polystyrenesulfonic acid polymer represented by the chemical formula (2).

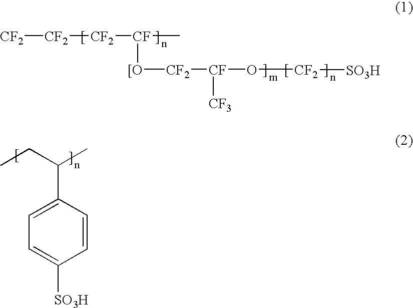

Alternatively, the acidic group-containing solid polymer may be made up of polymers represented by the following chemical formulas (3) and (4).

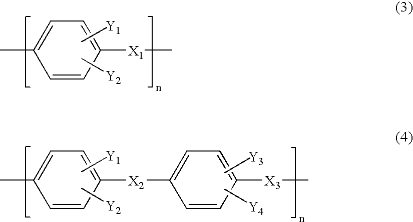

In chemical formulas (3) and (4), X1, X2, X3 are any one of S, SO₂, O, CO, and CH₂. X2 and X3 may be identical with each other, or they may be different from each other. On the other hand, at least one of Y1, Y2, Y3, Y4 is any one of SO₃H, OPO(OH)₂, and PO(OH)₂. Y1 and Y2, as well as Y3 and Y4, may be bonded to any position provided that the position does not relate to the main chain bond of the polymer. In the following description, the same functional groups will be indicated by the same symbols.

Other preferred examples of the acidic group-containing solid polymer include substances represented by the following chemical formulas (5) and (6).

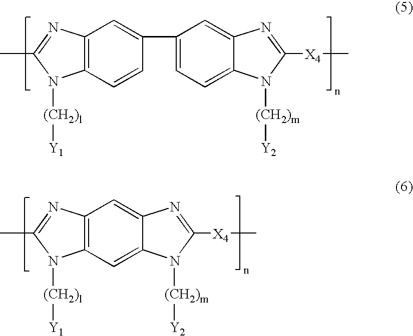

In chemical formulas (5) and (6), 1 and m are integers of 1 to 10, which may be the same integer or different integers. The structure of X4 may be represented by any one of the following chemical formulas.

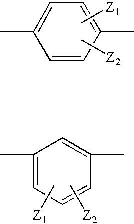

In the above chemical formulas, Z1 and Z2 are functional groups which are selected mutually independently from H, SO₃H, OPO(OH)₂, and PO(OH)₂.

Other preferred examples of the acidic group-containing solid polymer include substances represented by the following chemical formulas (7) and (8).

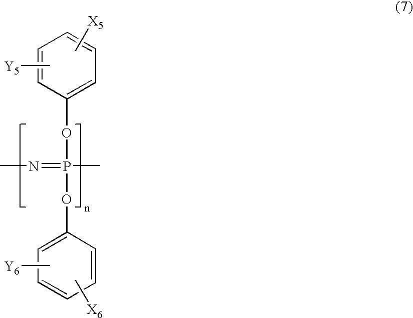

In chemical formula (7), X5 is SO₃H, and X6 is any one of H and SO₃H. Y5 and Y6 are functional groups, which are selected mutually independently from H, CH₃, C₂H₅, F, C1, and Br.

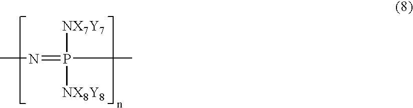

In chemical formula (8), X7 is (CH₂)ₘSO₃H (m=integer of 1 to 10), and X8 is any one of (CH₂)ₘSO₃H (m=integer of 1 to 10), NH₂, H, CH₃, C₂H₅, and C₆H₅ (phenyl group, hereinafter also referred to as “Ph”). Y7 and Y8 are functional groups, which are selected mutually independently from H, CH₃, C₂H₅, and Ph.

On the other hand, the ionic liquid may be selected from materials which are liquid at room temperature, and in which an organic cation and an anion thereof form an ionic bond with each other. Specified examples of organic cations include a pyridinium salt cation, which is one of aromatic cations represented by the chemical formula (9).

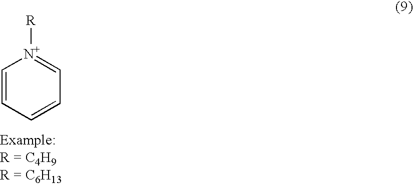

In chemical formula (9), for example, when R is n-butyl group or n-hexyl group, a 1-butylpyridinium cation or a 1-hexylpyridinium cation is given respectively.

Other examples of organic cations include heterocyclic cations such as an imidazolium salt cation represented by the chemical formula (10), a pyrazolium salt cation represented by the chemical formula (11), and a pyrrolidinium salt cation represented by the chemical formula (12).

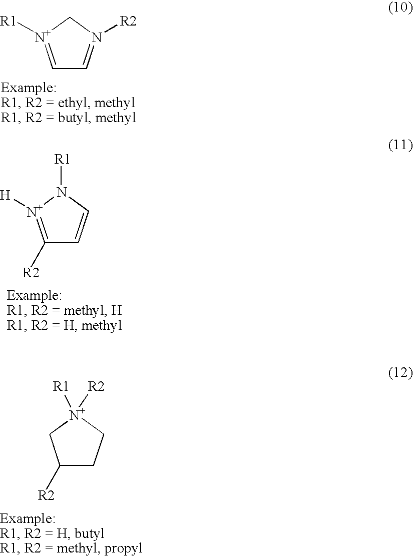

Specified examples of the imidazolium salt cation include a 1-ethyl-3-methylimidazolium cation in which R1 and R2 represent an ethyl group and a methyl group respectively, and a 1-butyl-3-methylimidazolium cation in which R1 and R2 represent a butyl group and a methyl group respectively.

Specified examples of the pyrazolium salt cation include a 1-methylpyrazolium cation in which R1 and R2 represent a methyl group and hydrogen respectively, and a 3-methylpyrazolium cation in which R1 and R2 represent hydrogen and a methyl group respectively.

Specified examples of the pyrrolidinium salt cation include a N-methylpyrrolidinium cation in which R1 and R2 represent hydrogen and an ethyl group respectively, and a N-methyl-N-propylpyrrolidinium cation in which R1 and R2 represent a methyl group and a n-propyl group respectively.

The organic cation may be an aliphatic cation. Preferred examples of aliphatic cations include an ethylammonium cation, as represented by the chemical formula (13), and a N,N-dimethyl-N-ethyl-N-propylammonium cation, as represented by the chemical formula (14).

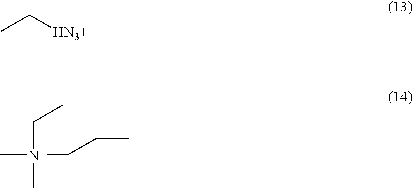

The anion, which forms the ionic bond together with the organic cation as described above, may be an organic anion or an inorganic anion. Usable organic anions include, for example, fluorine-containing anions such as a trifluoromethanesulfonate anion (CF₃SO₃⁻), a bis(trifluoromethylsulfonyl)imide anion ((CF₃SO₂)₂N⁻), and trifluoroboran (BF₄⁻).

Of course, other organic anions that do not contain fluorine may also be utilized. Such organic anions include a methanesulfonate anion (CH₃SO₃⁻) and an acetate anion (CH₃COO⁻).

Preferred examples of inorganic anions include a nitrate anion (NO₃⁻), a phosphate anion (H₂PO₄⁻), or a sulfate anion (HSO₄⁻).

The ionic liquid is retained at a ratio of 30 to 90% by weight with respect to the weight of the acidic group-containing solid polymer. If the ratio is less than 30% by weight, proton conductivity is insufficient. On the other hand, if the ratio exceeds 90% by weight, then the strength of the proton conductor (membrane) may decrease, and its durability may become poor.

In the embodiment of the present invention, the matrix has an excellent ability for retaining the ionic liquid. Therefore, disengagement of ionic liquid from the matrix can be prevented. Hence, the proton conductor exhibits excellent proton conductivity over a long period of time.

The ability of the proton conductor to retain the ionic liquid is evaluated by its retention ratio, which is determined from the weight change of the proton conductor before and after immersion, after the proton conductor has been immersed in water for 24 hours. In the embodiment of the present invention, the retention ratio of the proton conductor is not less than 50%. The proton conductor sometimes exhibits retention ratios of 90% and 100%.

When the proton conductor constructed as described above is used as an electrolyte in a fuel cell, then a fuel gas, containing hydrogen, is supplied to the anode electrode of the fuel cell, and an oxygen-containing gas, containing oxygen, is supplied to the cathode electrode. In this situation, hydrogen becomes ionized, forming protons and electrons on the anode electrode.

In particular, electrons are extracted from the fuel cell system to the outside, and the electrons are utilized as DC electric energy to energize an external load. Thereafter, the electrons arrive at the cathode electrode. On the other hand, protons arrive at one end surface of the proton conductor, and such protons are substituted by protons existing in the acidic group, such as a sulfonic acid group. Protons which are released by substitution, move slightly through the ionic liquid, and are substituted by protons of another acidic group existing in the vicinity of the aforementioned acidic group.

Protons are successively substituted and released as described above, and thus protons are moved through the proton conductor. Finally, the protons are moved to the other end surface of the proton conductor and arrive at the cathode electrode. The protons react with the electrons and oxygen contained in the oxygen-containing gas supplied to the cathode electrode, to thereby produce water.

The water makes contact with the proton conductor, which acts as an electrolyte. However, the matrix, which constitutes the proton conductor, has an excellent ability to retain the ionic liquid. Therefore, the ionic liquid is retained in the matrix, and the content of ionic liquid in the matrix is not deprived even if water makes contact therewith. In other words, even when water makes contact with the proton conductor, outflowing of the ionic liquid from the acidic group-containing solid polymer is prevented.

Hence, utilizing the proton conductor according to the above embodiment of the present invention, even in the case of contact with water, outflowing of the ionic liquid is suppressed and proton conductivity is maintained.

Further, the proton conductor retains the ionic liquid, which serves as a medium for moving protons. Therefore, even when the operation temperature of the fuel cell is not less than 100° C. and/or even when the fuel cell is operated in a low humidity environment, proton conductivity is not lowered. That is, proton conductivity, which is obtained when the fuel cell is operated in a high temperature low humidity state, is substantially equivalent to the proton conductivity obtained when the fuel cell is operated in a low temperature high humidity state. Accordingly, when the proton conductor is used as an electrolyte in a fuel cell, it is unnecessary to provide any additional humidifier or the like. Therefore, the fuel cell system may be compact and small-sized.

The proton conductor is also usable as an electrolyte in electrochemical cells other than fuel cells, including, for example, a hydrogen and oxygen generator for producing hydrogen and oxygen by electrolysis of water.

Next, an explanation shall be made concerning the method for producing the proton conductor. The production method according to the embodiment of the present invention comprises a first step of adding an acidic group-containing solid polymer to a solvent to prepare a solution, a second step of adding an ionic liquid to the solution, and a third step of casting the solution.

Initially, in the first step, the aforementioned acidic group-containing solid polymer is added to a solvent. In this procedure, any organic solvent other than methanol may be used. If methanol is used, the acidic group-containing solid polymer is aggregated during the third step, because the boiling point is low. As a result, the proton conductor is cracked in some cases.

A mixed liquid of water and an organic solvent may be used as the solvent. In this case, the ratio of water should be not more than 20% by weight. If the ratio exceeds 20% by weight, then water is aggregated in the third step, and hence the obtained membrane (proton conductor) is nonuniform. For reasons to be explained later, organic solvents having boiling points higher than that of water are preferably used.

Preferred examples of the aforementioned organic solvent include propanol or butanol when the acidic group-containing solid polymer is a perfluorosulfonic acid polymer. Propanol and butanol may be any one of structural isomers. The organic solvent may also be a mixture of propanol and butanol.

A mixed liquid is also available, in which a small amount of N-methyl-pyrrolidone, dimethylformamide, dimethylacetamide, or dimethylsulfoxide is added to propanol or butanol.

When the acidic group-containing solid polymer is an acidic group-containing hydrocarbon-based polymer, it is preferable to use, for example, N-methyl-pyrrolidone (NMP), dimethylformamide (DMF), dimethylacetamide (DMAc), or dimethylsulfoxide (DMSO), which have high polarity and easily dissolve the acidic group-containing solid polymer.

The acidic group-containing solid polymer is added at a ratio of 1 to 20% by weight with respect to the weight of the solvent as described above. If the ratio is less than 1% by weight, a long period of time is required due to an increase in the amount of solvent to be removed upon the formation of the membrane in the third step. If the ratio is larger than 20% by weight, undesirable aggregation may arise when the ionic liquid is added in the second step.

On the other hand, the ionic liquid is prepared by means of, for example, an acid ester method, a halide method, or a neutralization method.

In particular, the acid ester method is a method for reacting a base, which has a structure such that a cation is formed when the ionic liquid is formed, and an acid ester, which has a structure such that an anion is formed when the ionic liquid is formed. For example, the reaction is advanced in accordance with the following chemical reaction formula (A).

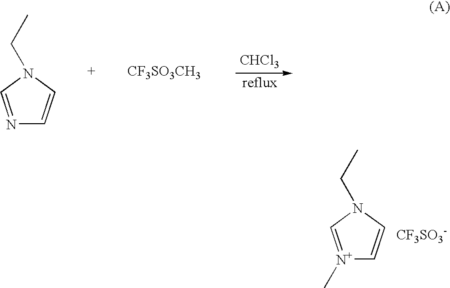

In the halide method, a halogen anion of halide, having a structure such that a cation is formed when the ionic liquid is formed, is ion-exchanged with an anion of a metal salt, having a structure such that an anion is formed when the ionic liquid is formed. Specified examples include the reaction represented by the following chemical reaction formula (B).

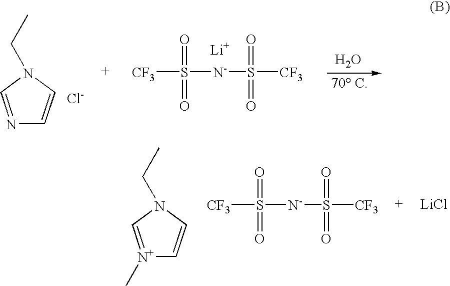

In the neutralization method, an ionic liquid is obtained utilizing a neutralization reaction between a base, having a structure such that a cation is formed when the ionic liquid is formed, and an acid, having a structure such that an anion is formed when the ionic liquid is formed. Specified examples include the reaction represented by the following chemical reaction formula (C).

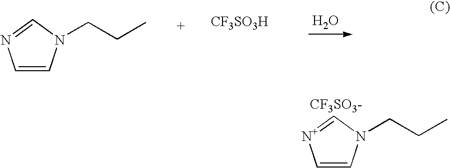

In the second step, the ionic liquid obtained as described above is added to the solution obtained by dissolving the acidic group-containing solid polymer, and thus a casting liquid is prepared. In this procedure, the ratio at which the ionic liquid is added is 30 to 90% by weight with respect to the weight of the acidic group-containing solid polymer. Agitation may be performed for about 10 minutes.

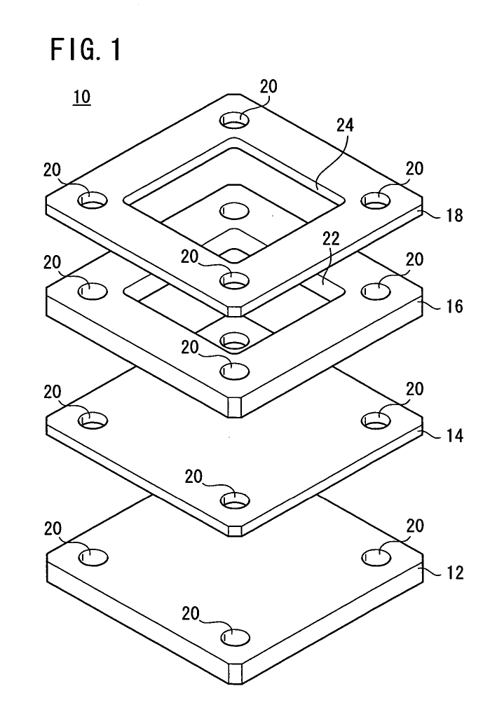

In the third step, the casting liquid is subjected to casting in a casting vessel 10, as illustrated in FIG. 1.

The casting vessel 10 includes a lower base member 12 made of stainless steel, a sheet member 14 composed of polytetrafluoroethylene (PTFE) as a fluorine-containing polymer material, a frame 16 composed of PTFE, and an upper base member 18 made of stainless steel. The lower base member 12, the sheet member 14, the frame 16, and the upper base member 18 are joined to one another by means of unillustrated bolts that pass through bolt holes 20. Openings 22, 24 are provided for the frame 16 and the upper base member 18 respectively.

The casting liquid is introduced via the opening 24 into a cavity which is formed by the sheet member 14 and the opening 22 of the frame 16. Of course, the casting liquid is introduced in an amount such that the liquid surface does not arrive at the opening 24 of the upper base member 18.

The casting liquid is introduced into a heating furnace together with the casting vessel 10, and heat treatment is applied in order to remove the solvent. The conditions for such heat treatment may be appropriately set depending on the type of the acidic group-containing solid polymer that is used. For example, in the case of a perfluoroalkylsulfonic acid, the casting liquid may be heated at 35 to 45° C. for 4 to 6 hours, followed by heating at 140 to 160° C. for 0.5 to 1.5 hours. In the case of a hydrocarbon-based acidic polymer, the casting liquid may be heated at 80° C. for 8 hours, and thereafter vacuum-dried at 100° C. for 8 hours.

During this procedure, if the organic solvent contained in the solvent has a boiling point considerably lower than that of water, there is a strong tendency that the organic solvent will become evaporated earlier. As a result of this situation, aggregation arises on the sheet member 14 made of PTFE, because the remaining major component of the solvent is simply water. Thus, the obtained membrane can become cracked in some cases. In order to avoid such an occurrence, it is preferable to use organic solvents having higher boiling points as compared to water. When organic solvents having boiling points lower than that of water are used, it is preferable that the boiling points thereof be not less than 80° C.

After the solvent has been removed as described above, the bolts of the casting vessel 10 are loosened to detach the lower base member 12 and the upper base member 18. Subsequently, when one end of the sheet member 14 is pulled and disengaged from the frame 16, the membrane (proton conductor) adhered to the opening 22 is exposed. Upon such disengagement, the fluorine-containing polymer represented by PTFE is easily exfoliated from the membrane. That is, the membrane itself is not stuck to or pulled by the sheet member 14. Therefore, the sheet member can be disengaged from the membrane, without causing scratches or cut lines in the membrane.

The membrane, which has neither scratches nor cracks therein, is consequently obtained by cutting off the end of the membrane from the opening 22 of the frame 16.

As described above, in the embodiment of the present invention, casting is performed in a cavity, which is formed by the frame 16 and the sheet member 14 made of PTFE. Therefore, the membrane is obtained easily and conveniently without scratches or cracks.

### EXAMPLE 1

19.2 g (0.2 mole) of 1-ethylimidazole was dissolved in 200 ml of 1,1,1-trichloroethane in an eggplant-shaped flask having a volume of 500 ml. 32.1 g (0.2 mole) of methyltrifluoromethane sulfonate was added dropwise to this solution over 1 hour or more. Accordingly, the chemical reaction formula (A) was advanced.

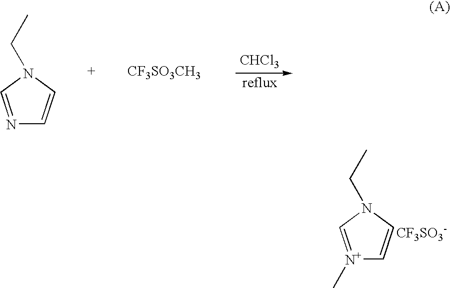

Reflux was performed for 2 hours, the product was separated by means of a separatory process, and the product was washed twice with 100 ml of 1,1,1-trichloroethane. After that, drying was performed under reduced pressure to obtain 47 g (0.18 mole) of 1-ethyl, 3-methylimidazolinium trifluoromethane sulfonate (EMI-Tf) as an ionic liquid.

Subsequently, Nafion, which is a perfluorosulfonic acid polymer, was dissolved in a solvent comprising 10% by weight of pure water and 90% by weight of propanol, so that the amount of Nafion was 5% by weight with respect to the weight of the solvent. EMI-Tf, which was obtained as described above, was added to this solution at ratios of 30% by weight, 40% by weight, 60% by weight, and 80% by weight respectively, with respect to the weight of Nafion, followed by being agitated for 10 minutes to prepare respective casting liquids.

Each of the casting liquids was subjected to casting in the casting vessel 10 shown in FIG. 1, which was heated at 40° C. for 5 hours in the heating furnace, followed by heating at 150° C. for 1 hour to remove the solvent. Accordingly, respective membranes were produced, each of which was adhered to the opening 22 of the frame 16. Each of the membranes was cut from the end. Thus, respective membranes were obtained, each of which had a width of 30 mm, a length of 30 mm, and a thickness of 50 μm.

### EXAMPLE 2

12 g (0.082 mole) of 1-ethyl, 3-methylimidazolium chloride was dissolved in 100 ml of pure water in an eggplant-shaped flask having a volume of 500 ml. The solution was heated to 70° C., and another solution was slowly added thereto dropwise, the other solution being obtained by dissolving 23.50 g (0.082 mole) of lithium bis[(trifluoromethyl)sulfonyl]imide in 200 ml of pure water. Accordingly, the chemical reaction formula (B) was advanced.

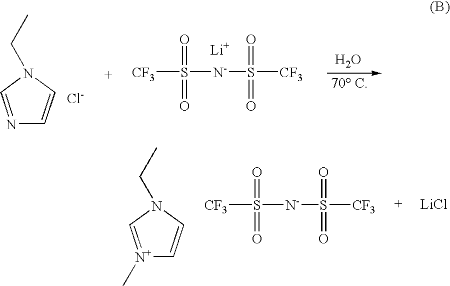

Following dropwise addition of the other solution, a separatory process was performed, and the product obtained thereby was washed twice with 60 ml of pure water. After that, drying was performed under a reduced pressure to obtain 29.3 g (0.074 mole) of 1-ethyl, 3-methylimidazolium bis[(trifluoromethyl)sulfonyl]imide (EMI-TFSI) as an ionic liquid.

Thereafter, the process was continued in the same manner as in Example 1, to obtain respective membranes each having a width of 30 mm, a length of 30 mm, and a thickness of 50 μm, in which EMI-TFSI was retained by Nafion at ratios of 30% by weight, 40% by weight, 60% by weight, and 80% by weight with respect to the weight of Nafion.

### COMPARATIVE EXAMPLE 1

It was tried to obtain membranes, each having a width of 30 mm, a length of 30 mm, and a thickness of 50 μm, in which EMI-Tf was retained by Nafion at ratios of 10 t by weight, 20% by weight, and 92% by weight with respect to the weight of Nafion, in the same manner as in Example 1. However, when the amount of added EMI-Tf was 92% by weight, the product remained in a fluidic state, and a solid form membrane could not be obtained.

### COMPARATIVE EXAMPLE 2

It was tried to obtain membranes each having a width of 30 mm, a length of 30 mm, and a thickness of 50 μm, in which EMI-TFSI was retained by Nafion at ratios of 20% by weight and 92% by weight with respect to the weight of Nafion, in accordance with Example 2. However, when the amount of added EMI-TFSI was 92% by weight, then the product remained in a fluidic state, and a solid form membrane could not obtained, in the same manner as in Comparative Example 1.

### COMPARATIVE EXAMPLE 3

It was tried to manufacture membranes in which the ratios of EMI-Tf or EMI-TFSI were 40% by weight, 60% by weight, and 80% by weight with respect to the weight of Nafion, in accordance with Example 1 or in accordance with Example 2, except that the solvent contained 50% by weight of pure water and 50% by weight of propanol. However, in this case, the membranes, which were obtained by applying a heat treatment using a heating furnace, became shrunk and/or cracked. That is, uniform membranes could not be obtained.

### COMPARATIVE EXAMPLE 4

Nafion, having a width of 30 mm, a length of 30 mm, and a thickness of 50 μm, and for which the dry weight was measured beforehand, was immersed at 40° C. for 24 hours in a petri dish made of glass, which contained 20 ml of EMI-TFSI, in order to impregnate the Nafion with EMI-TFSI. The impregnated Nafion was taken out, and any excessive EMI-TFSI was wiped from its surface, and thereafter the weight of the impregnated Nafion was measured. According to the measurement, it was confirmed that Nafion was impregnated with 40% by weight of EMI-TFSI, with respect to the initial dry weight of Nafion.

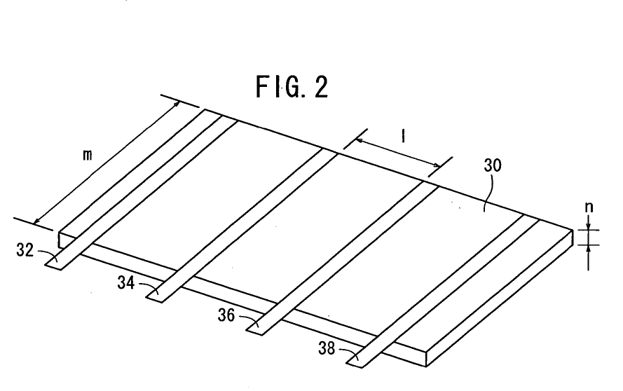

Subsequently, as shown in FIG. 2, respective test pieces 30, having dimensions of 10 mm×30 mm, were cut out from each of the membranes obtained as described above, along with a commercially available Nafion membrane. An acting electrode 32, a first reference electrode 34, a second reference electrode 36, and a counter electrode 38 were attached to the test pieces 30 in order to measure proton conductivity, at a temperature of 140° C. in accordance with an AC complex impedance method. An Impedance Analyzer S-1260, produced by Solartron, was used as the measuring instrument.

Proton conductivity was determined in accordance with the following calculating formula (i). In the calculating formula (i), δ represents proton conductivity (S/cm), R represents resistance (Ω), 1 represents a spacing distance (cm) between the electrodes, m represents the widthwise dimension (cm) of each of the test pieces 30, and n represents the thickness (cm) of the test pieces 30.
δ=1/(R·m·n) (i)
δ[S/cm]: proton conductivity, R [Ω]: resistance, 1 [m]: spacing distance between electrodes, m [cm]: width, n [cm]: thickness.

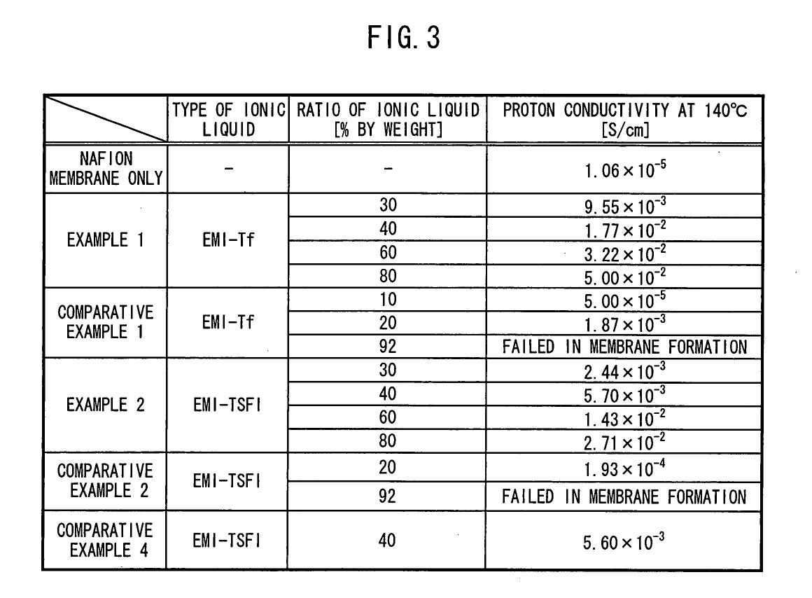

The proton conductivities of the respective membranes are shown together in FIG. 3. Observing FIG. 3, it is clear that the membranes (proton conductors) of Examples 1 and 2 each exhibit excellent proton conductivity.

In particular, it is clearly understood that when the ratio of the ionic liquid is dramatically increased, i.e., to 80% by weight with respect to the weight of Nafion, proton conductivity greatly improves five times or ten times more, as compared with the case in which the ratio of the ionic liquid is only 30% by weight.

Subsequently, the weight W1 of the membrane manufactured in accordance with Example 2, in which the ratio of EMI-TFSI was 40% by weight with respect to the weight of Nafion, was measured. The membrane was immersed in 50 ml of pure water, followed by being agitated at room temperature for 24 hours. Thereafter, the membrane was removed from the pure water, and the membrane was dried in vacuum at 100° C. for 6 hours, in order to measure the post-immersion weight W2 of the membrane. The retention ratio of EMI-TFSI was calculated from W1 and W2 in accordance with the following calculating formula (ii). The retention ratio was 100%, and it was confirmed that no EMI-TFSI flowed out from the membrane at all.
Retention ratio (%)=[{W1×0.4−(W1−W2)}/(W1×0.4)]×100 (ii)

The retention ratio also was calculated in the same manner as described above for the membrane manufactured in Comparative Example 4 (immersing method). As a result, the measured retention ratio was as low as 5%. That is, almost all of the EMI-TFSI flowed out.

According to the above result, it is clear that the membrane of Example 2 possesses an excellent ability to retain ionic liquid, as compared with other membranes manufactured in accordance with conventional immersing methods.

The proton conductor of the present invention preferably is used as an electrolyte in an electrochemical cell, such as a fuel cell or an electrolysis apparatus.

While the invention has been particularly shown and described with reference to preferred embodiments, it will be understood that variations and modifications can be effected thereto by those skilled in the art without departing from the spirit and scope of the invention as defined by the appended claims.

1. A proton conductor comprising an ionic liquid retained by a matrix composed of an acidic group-containing solid polymer having an acidic group, said ionic liquid including a cation and an anion which are subjected to ionic bonding, and said ionic liquid being a liquid at room temperature, wherein:
said ionic liquid is retained at a ratio of 30 to 90% by weight with respect to a weight of said matrix; and
a retention ratio of said ionic liquid in said matrix, which is obtained after passage of 24 hours from being immersed in water, is not less than 50%.

2. The proton conductor according to claim 1, wherein said acidic group-containing solid polymer is a polymer which has, as said acidic group, a sulfonic acid group, a phosphoric acid group, or a phosphonic acid group.

3. The proton conductor according to claim 2, wherein said ionic liquid is a substance in which an ionic bond is formed by a nitrogen-containing organic cation and an anion.

4. The proton conductor according to claim 2, wherein said acidic group-containing solid polymer is a perfluorosulfonic acid polymer.

5. The proton conductor according to claim 2, wherein said acidic group-containing solid polymer is an acidic group-containing hydrocarbon-based polymer.

6. The proton conductor according to claim 3, wherein said nitrogen-containing organic cation is any one of a pyridinium salt cation, a pyrazolium salt cation, a pyrrolidinium salt cation, and an aliphatic cation.

7. The proton conductor according to claim 3, wherein said anion is a fluorine-containing organic anion.

8. The proton conductor according to claim 7, wherein said fluorine-containing organic anion is any one of a trifluoromethanesulfonate anion, a bis(trifluoromethylsulfonyl)imide anion, and trifluoroboran.

9. The proton conductor according to claim 3, wherein said anion is a nitrate anion, a phosphate anion, or a sulfate anion.

10. The proton conductor according to claim 1, wherein said retention ratio of said ionic liquid in said matrix, which is obtained after passage of 24 hours from being immersed in water, is not less than 90%.

11. The proton conductor according to claim 1, wherein said retention ratio of said ionic liquid in said matrix, which is obtained after passage of 24 hours from being immersed in water, is 100%.

12. A method for producing a proton conductor, comprising the steps of:
dissolving an acidic group-containing solid polymer having an acidic group at a ratio of 1 to 20% by weight of a solvent to prepare a solution;
adding an ionic liquid to said solution at a ratio of 30 to 90% by weight of said acidic group-containing solid polymer, said ionic liquid including a cation and an anion which are subjected to ionic bonding, and said ionic liquid being a liquid at room temperature; and
a step of obtaining a proton conductor by performing casting with said solution,
wherein said solvent comprises an organic solvent other than methanol.

13. The method for producing a proton conductor according to claim 12, wherein said solvent contains water of not more than 20% by weight, and said organic solvent is a liquid having a boiling point of not less than 80° C.

14. The method for producing a proton conductor according to claim 12, wherein said solution is subjected to casting in a casting vessel including an outer frame made of a fluorine-containing polymer material and a sheet made of a fluorine-containing polymer material.

15. The method for producing a proton conductor according to claim 14, wherein said outer frame made of said fluorine-containing polymer material and said sheet made of said fluorine-containing polymer material are separated from each other and said proton conductor is removed from said outer frame made of said fluorine-containing polymer material.

16. The method for producing a proton conductor according to claim 12, wherein propanol or butanol is used as said organic solvent when said acidic group-containing solid polymer is a perfluorosulfonic acid-based polymer.

17. The method for producing a proton conductor according to claim 12, wherein N-methyl-pyrrolidone, dimethylformamide, dimethylacetamide, or dimethylsulfoxide is used as said organic solvent when said acidic group-containing solid polymer is an acidic group-containing hydrocarbon-based polymer.

18. The method for producing a proton conductor according to claim 14, wherein each of said outer frame made of said fluorine-containing polymer material and said sheet made of said fluorine-containing polymer material is composed of polytetrafluoroethylene.
